(19) United States
(12) Patent Application Publication
(10) Pub. No.: US 2024/0390808 A1
(43) Pub. Date: Nov. 28, 2024

(54) GAME STAND

(71) Applicant: GT OMEGA RACING LTD, Renfrewshire (GB)

(72) Inventor: Shengduan Li, Guangdong (CN)

(73) Assignee: GT OMEGA RACING LTD, Renfrewshire (GB)

(21) Appl. No.: 18/690,406

(22) PCT Filed: Sep. 8, 2022
(86) PCT No.: PCT/GB2022/052289

§ 371 Date: Mar. 8, 2024

(30) Foreign Application Priority Data
Sep. 10, 2021 (CN) 202122201704.3

(51) Int. Cl. A63F 13/98; A63F 13/803; F16M 11/10; F16M 11/38

(52) U.S. Cl. CPC A63F 13/98; F16M 11/10; F16M 11/38; A63F 13/803

(57) ABSTRACT

The present disclosure provides a game stand, relates to the technical field of articles of daily use and solves a technical problem of an unsatisfactory use effect of a game stand in the prior art. The game stand includes a stand body and a pedal assembly, wherein the stand body has a first rack and a second rack which are connected in a foldable mode, a mounting panel is arranged on the first rack, and an angle adjusting structure is arranged between the mounting panel and the first rack; and the pedal assembly includes a pedal and a supporting portion, one end of the pedal is hinged to the second rack, one end of the supporting portion is hinged to a middle portion of the pedal, the other end of the supporting portion is hinged to the first rack, and thus the pedal can be folded synchronously when the first rack and the second rack are folded. The present disclosure is used to provide the game stand which saves space and improves the use effect of a game player.

### TECHNICAL FIELD

The present disclosure relates to the technical field of articles of daily use, in particular to a game stand.

### BACKGROUND

A game stand is mainly used for placing a steering wheel, a pedal, and a gear lever of a car racing game. However, different people have different demands for a height of the game stand, a height of the pedal, and an angle position of the steering wheel, so a game player can be in the most comfortable position when interacting with the game, which needs the game stand to have an adjusting function. Game stands existing on the market are highly limited in application, cannot be adjusted at will according to demands of different users and are unsatisfactory in use effect.

Besides, the existing game stands occupy a large space and are not light and convenient enough.

The applicant finds that there is at least the following technical problem in the prior art: the existing game stands are unsatisfactory in use effect.

### SUMMARY

An objective of the present disclosure is to provide a game stand so as to solve the technical problem of an unsatisfactory use effect of a game stand in the prior art. Various technical effects generated by preferred technical solutions in various technical solutions provided by the present disclosure are set forth below in detail.

In order to achieve the above objective, the present disclosure provides the following technical solutions.

The game stand provided by the present disclosure includes a stand body and a pedal assembly, wherein the stand body has a first rack and a second rack which are connected in a foldable mode, a mounting panel is arranged on the first rack, and an angle adjusting structure is arranged between the mounting panel and the first rack; and the pedal assembly includes a pedal and a supporting portion, one end of the pedal is hinged to the second rack, one end of the supporting portion is hinged to a middle portion of the pedal, the other end of the supporting portion is hinged to the first rack, and thus the pedal can be folded synchronously when the first rack and the second rack are folded.

As an improvement of the present disclosure, the angle adjusting structure includes an adjusting plate arranged on the first rack, a plurality of adjusting holes are formed in the adjusting plate, the mounting panel is securely connected to the adjusting holes through bolts, and the bolts can move up and down in the adjusting holes so that an angle of the mounting panel is adjusted.

As a further improvement of the present disclosure, a position-limiting structure is arranged on the first rack, and the other end of the pedal is in lap joint with the position-limiting structure, so that the first rack and the second rack are at a fixed angle after being unfolded.

As a further improvement of the present disclosure, the position-limiting structure includes a movable sleeve arranged on the first rack, the movable sleeve is arranged on the first rack in a sleeving mode, and the movable sleeve can be adjusted through a bolt so that the movable sleeve is fixed at any position of the first rack.

As a further improvement of the present disclosure, the first rack includes two first vertical rods parallel to each other and a first cross rod which is connected to ends of the two first vertical rods, and the mounting panel is connected between the other ends of the two first vertical rods.

As a further improvement of the present disclosure, the second rack includes two second vertical rods parallel to each other and a second cross rod which is connected to ends of the two second vertical rods, and the other ends of the two second vertical rods are hinged to middle portions of the two first vertical rods respectively.

As a further improvement of the present disclosure, a fastener is arranged on the second rack, a fixing hole is formed in the pedal, and after the first rack and the second rack are folded, the fastener is inserted into the fixing hole so that the first rack and the second rack are in a folded state.

As a further improvement of the present disclosure, the first vertical rods are telescopic rods, and tightening nuts are arranged on the telescopic rods.

As a further improvement of the present disclosure, a gear lever supporting seat is further arranged on the stand body.

As a further improvement of the present disclosure, the angle adjusting structure includes a fixing substrate, the fixing substrate is connected to the stand body, a threaded rod is arranged on the fixing substrate, a knob is arranged at one end of the threaded rod, the knob can be rotated to drive the threaded rod to rotate, a sliding block is arranged on the threaded rod and hinged to one side of the bottom of the mounting panel, and the other side of the bottom of the mounting panel is hinged to the fixing substrate.

The present disclosure has the beneficial effects as follows: the game stand provided by the present disclosure has the first rack and the second rack which are connected in a foldable mode, the pedal and the supporting portion are connected with the first rack and the second rack respectively, so the pedal assembly and the stand body are folded synchronously, and the game stand can be folded and stored when not in use so as to save space; and besides, the angle adjusting structure is arranged between the mounting panel and the first rack and can adjust a placement angle of the mounting panel, so that a steering wheel arranged on the mounting panel can be put in the most comfortable position for a game player, and the use effect and user comfort are improved.

Various further features and aspects of the invention are defined in the claims.

### BRIEF DESCRIPTION OF THE DRAWINGS

In order to describe the technical solutions of the embodiments of the present disclosure or in the prior art more clearly, accompanying drawings to be used in the description of the embodiments or the prior art will be briefly introduced below.

Apparently, the accompanying drawings in the following description are merely some embodiments of the present disclosure, and those of ordinary skill in the art can also obtain other drawings according to these accompanying drawings without creative work.

FIG. 1 is a three-dimensional diagram (I) of the present disclosure.

FIG. 2 is a three-dimensional diagram (II) of the present disclosure.

FIG. 3 is a side view of the present disclosure.

FIG. 4 is a diagram of a folded state of the present disclosure.

FIG. 5 is a schematic diagram of partial structure of a second embodiment of the present disclosure.

In the drawings, 1, first rack; 2, second rack; 3, mounting panel; 4, adjusting plate; 5, gear lever supporting seat; 6, pedal; 7, supporting portion; 11, first vertical rod; 12, first cross rod; 13, movable sleeve; 21, second vertical rod; 22, second cross rod; 23, fastener; 61, fixing hole; 81, fixing substrate; 82, threaded rod; 83, knob; 84, sliding block.

### DETAILED DESCRIPTION

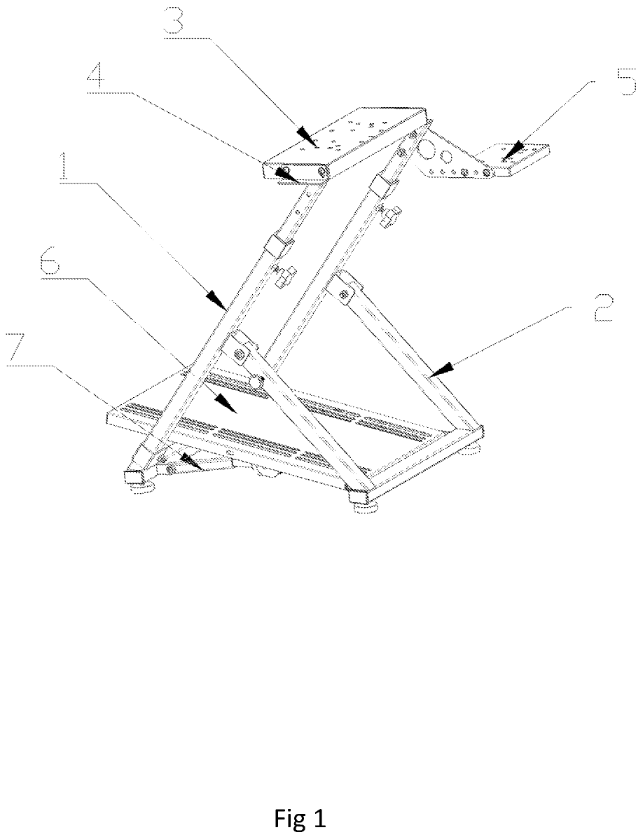

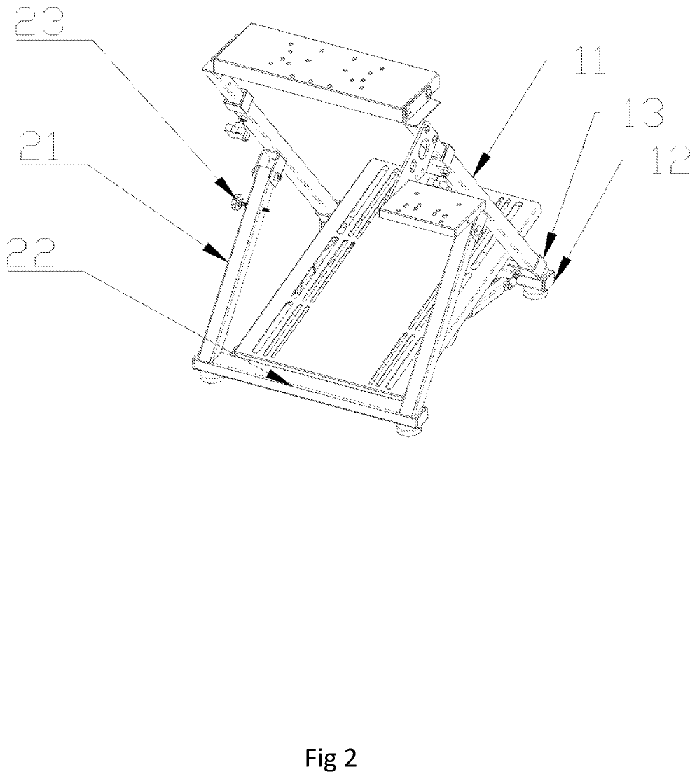

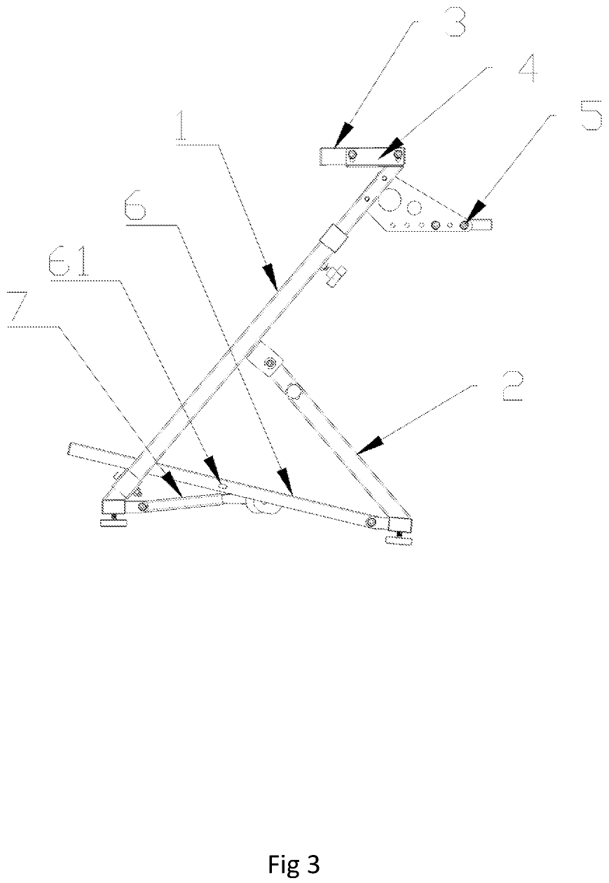

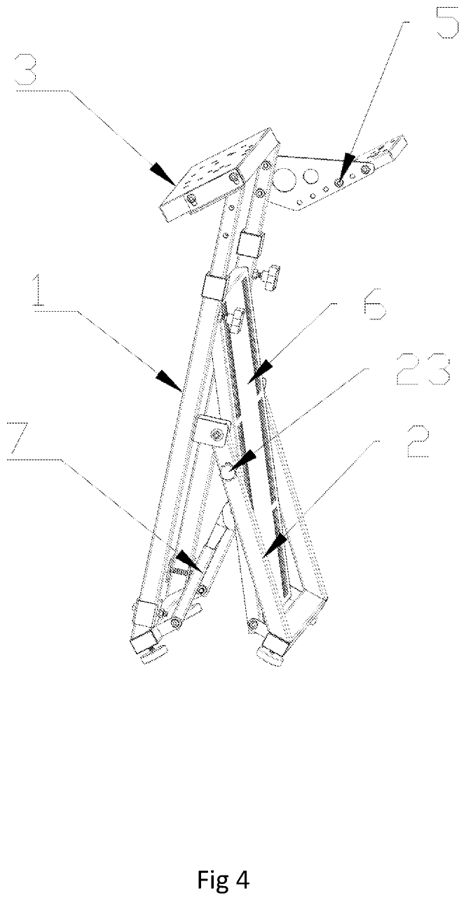

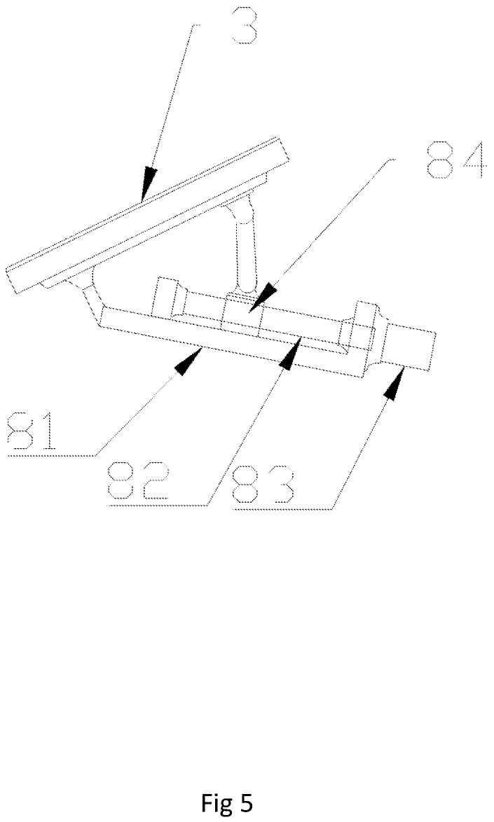

Contents of the present disclosure and differences between the present disclosure and the prior art can be understood with reference to the accompanying drawings of FIG. 1 to FIG. 5 and text contents below. The technical solutions (including preferred technical solutions) of the present disclosure can be further described in detail below through the accompanying drawings and by listing some optional embodiments of the present disclosure. It needs to be noted that any technical feature or any technical solution of the embodiments is one or several types of various optional technical features or optional technical solutions, for concise description, all replaceable technical features and replaceable technical solutions of the present disclosure cannot be listed exhaustively herein, nor can an implementation of each technical feature be emphasized as one of various optional implementations, so those of skill in the art should realize that any technical means provided by the present disclosure may be replaced or any two or more technical means or technical features provided by the present disclosure may be combined mutually to obtain a new technical solution. Any technical feature and any technical solution in the embodiments do not limit the protection scope of the present disclosure. The protection scope of the present disclosure should include any substituted technical solution that those of skill in the art may figure out without creative work and a new technical solution obtained by combining any two or more technical means or technical features provided by the present disclosure by those of skill in the art.

In the description of the present disclosure, it needs to be noted that unless otherwise stated, “a plurality of” means two or more than two; a direction or a location relation indicated by terms such as “upper”, “lower”, “left”, “right”, “inner”, “outer”, “front end”, “rear end”, “head” and “tail” is based on a direction or a location relation shown in the accompanying drawings and is merely for convenient description of the present disclosure and simplifying the description, but is not for indicating or implying that a referred apparatus or element must have a specific direction or be constructed and operated in a specific direction, and thus it cannot be constructed as a limit on the present disclosure. Besides, terms such as “first”, “second” and “third” are merely for description but not for being regarded as indicating or implying a relative significance.

In the description of the present disclosure, it needs to be further noted that unless otherwise clearly specified and limited, terms such as “mounted/mounting”, “connected/connecting” and “joint” should be understood in a broad sense. For example, it may be a fixed connection, a detachable connection or an integrated connection; or may be a mechanical connection or an electrical connection; or may be a direct connection or an indirect connection through an intermediate medium. Those of ordinary skill in the art can understood specific meanings of the above terms in the present disclosure according to specific conditions.

The present disclosure provides a game stand which saves space and improves the use effect of a game player.

The technical solutions provided by the present disclosure are set forth in more details below with reference to FIG. 1 to FIG. 5.

The present disclosure provides a game stand, including a stand body and a pedal assembly, wherein the stand body has a first rack and a second rack which are connected in a foldable mode, a mounting panel is arranged on the first rack, and an angle adjusting structure is arranged between the mounting panel and the first rack; and the pedal assembly includes a pedal and a supporting portion, one end of the pedal is hinged to the second rack, one end of the supporting portion is hinged to a middle portion of the pedal, the other end of the supporting portion is hinged to the first rack, and thus the pedal can be folded synchronously when the first rack and the second rack are folded.

The game stand provided by the present disclosure has the first rack and the second rack which are connected in a foldable mode, the pedal and the supporting portion are connected with the first rack and the second rack respectively, so the pedal assembly and the stand body are folded synchronously, and the game stand can be folded and stored when not in use so as to save space; and besides, the angle adjusting structure is arranged between the mounting panel and the first rack and can adjust a placement angle of the mounting panel, so that a steering wheel arranged on the mounting panel can be put in the most comfortable position for a game player, and the use effect and user comfort are improved.

As an improvement of the present disclosure, the angle adjusting structure includes an adjusting plate arranged on the first rack, a plurality of adjusting holes are formed in the adjusting plate, the mounting panel is securely connected to the adjusting holes through bolts, and the bolts can move up and down in the adjusting holes so that an angle of the mounting panel is adjusted.

The adjusting plate is arranged on the first rack, the adjusting holes are formed in the adjusting plate, the bolts penetrate through the adjusting plate and the mounting panel to be connected with nuts, and thus the adjusting plate and the mounting panel are secured. Each of the adjusting holes is a long-strip hole, and by adjusting relative positions of the mounting panel and the adjusting plate, adjustment of an angle of the steering wheel on the mounting panel is realized, so the adjustment is convenient and fast.

As a further improvement of the present disclosure, a position-limiting structure is arranged on the first rack, and the other end of the pedal is in lap joint with the position-limiting structure, so that the first rack and the second rack are at a fixed angle after being unfolded.

As a further improvement of the present disclosure, the position-limiting structure includes a movable sleeve arranged on the first rack, the movable sleeve is arranged on the first rack in a sleeving mode, and the movable sleeve can be adjusted through a bolt so that the movable sleeve is fixed at any position of the first rack.

By arranging the position-limiting structure, a height of the pedal can be adjusted, so that the pedal is located in the most comfortable position for the game player. Specifically, by arranging the movable sleeve that may be tightened or loosened through the bolt, the movable sleeve is arranged at any position of the first rack in a sleeving mode.

As a further improvement of the present disclosure, the first rack includes two first vertical rods parallel to each other and a first cross rod which is connected to ends of the two first vertical rods, and the mounting panel is connected between the other ends of the two first vertical rods.

As a further improvement of the present disclosure, the second rack includes two second vertical rods parallel to each other and a second cross rod which is connected to ends of the two second vertical rods, and the other ends of the two second vertical rods are hinged to middle portions of the two first vertical rods respectively.

As a further improvement of the present disclosure, a fastener is arranged on the second rack, a fixing hole is formed in the pedal, and after the first rack and the second rack are folded, the fastener is inserted into the fixing hole so that the first rack and the second rack are in a folded state.

The fastener and the fixing hole cooperate and can fix the pedal and the stand body in a folded state after the first rack and the second rack are folded, so that the game stand can be stored when not in use so as to save space.

As a further improvement of the present disclosure, the first vertical rods are telescopic rods, and tightening nuts are arranged on the telescopic rods. The first vertical rods are the telescopic rods, and the telescopic rods can adjust a height of the mounting panel at will, so that demands of different game players for heights are met.

As a further improvement of the present disclosure, a gear lever supporting seat is further arranged on the stand body. The gear lever supporting seat is used for fixing a gear lever and may be arranged on a left side or a right side of the stand body. Specifically, a through hope may be formed in the telescopic rod, and the gear lever supporting seat is fixed to the telescopic rod through a bolt and a nut. The gear lever supporting seat may also be securely fixed to the telescopic rod by using cooperation of a groove and a protruding block.

As a further improvement of the present disclosure, the angle adjusting structure includes a fixing substrate, the fixing substrate is connected to the stand body, a threaded rod is arranged on the fixing substrate, a knob is arranged at one end of the threaded rod, the knob can be rotated to drive the threaded rod to rotate, a sliding block is arranged on the threaded rod and hinged to one side of the bottom of the mounting panel, and the other side of the bottom of the mounting panel is hinged to the fixing substrate.

As for the above structure, when the angle of the steering wheel is to be adjusted, the adjustment can be achieved only by rotating the knob, which is more efficient and faster.

### Embodiment 1

The game stand provided by the present disclosure includes a stand body and a pedal assembly, wherein the stand body has a first rack 1 and a second rack 2 which are connected in a foldable mode, a mounting panel 3 is arranged on the first rack 1, and an angle adjusting structure is arranged between the mounting panel 3 and the first rack 1; and specifically, the angle adjusting structure includes an adjusting plate 4 arranged at the top of the first rack 1, a plurality of long-strip adjusting holes are formed in the adjusting plate 4, the mounting panel 3 is securely connected to the adjusting plate 4 by making bolts penetrate through the adjusting holes, and the bolts can move up and down in the adjusting holes so that an angle of the mounting panel 3 is adjusted. A gear lever supporting seat 5 is further arranged on a side of the first rack 1.

The pedal assembly includes a pedal 6 and a supporting portion 7, one end of the pedal 6 is hinged to the second rack 2, one end of the supporting portion 7 is hinged to a middle portion of the pedal 6, the other end of the supporting portion 7 is hinged to the first rack 1, and thus the pedal 6 can be folded synchronously when the first rack 1 and the second rack 2 are folded.

Specifically, the first rack 1 includes two first vertical rods 11 parallel to each other and a first cross rod 12 which is connected to ends of the two first vertical rods 11, and the mounting panel 3 is connected between the other ends of the two first vertical rods 11.

The second rack 2 includes two second vertical rods 21 parallel to each other and a second cross rod 22 which is connected to ends of the two second vertical rods 21, and the other ends of the two second vertical rods 21 are hinged to middle portions of the two first vertical rods 11 respectively.

A fastener 23 is arranged on the second rack 21, a fixing hole 61 is formed in the pedal 6, and after the first rack 1 and the second rack 2 are folded, the fastener 23 is inserted into the fixing hole 61 so that the first rack 1 and the second rack 2 are in a folded state.

A movable sleeve 13 is arranged on the first vertical rod 11 in a sleeving mode and can be adjusted through a bolt, and thus the movable sleeve 13 is fixed at any position of the first vertical rod 11.

### Embodiment 2

Differences between embodiment 2 and embodiment 1 are that the angle adjusting structure includes a fixing substrate 81, the fixing substrate 81 is connected to the stand body, a threaded rod 82 is arranged on the fixing substrate 81, a knob 83 is arranged at one end of the threaded rod 82, the knob 83 can be rotated to drive the threaded rod 82 to rotate, a sliding block 84 is arranged on the threaded rod 82 and hinged to one side of the bottom of the mounting panel 3, and the other side of the bottom of the mounting panel 3 is hinged to the fixing substrate 81.

The above description is merely specific implementations of the present disclosure, but the protection scope of the present disclosure is not limited to this, and changes or replacements that any person of skill familiar with the art easily figure out in the technical scope disclosed by the present disclosure should fall within the protection scope of the present disclosure. Thus, the protection scope of the present disclosure should be determined by the protection scope of claims.

1. A game stand, comprising a stand body and a pedal assembly, wherein the stand body has a first rack and a second rack which are connected in a foldable mode, a mounting panel is arranged on the first rack, and an angle adjusting structure is arranged between the mounting panel and the first rack; and
the pedal assembly includes a pedal and a supporting portion, one end of the pedal is hinged to the second rack, one end of the supporting portion is hinged to a middle portion of the pedal, the other end of the supporting portion is hinged to the first rack, and thus the pedal can be folded synchronously when the first rack and the second rack are folded.

2. The game stand according to claim 1, wherein the angle adjusting structure comprises an adjusting plate arranged on the first rack, a plurality of long-strip adjusting holes are formed in the adjusting plate, the mounting panel is securely connected to the adjusting holes through bolts, and the bolts can move up and down in the adjusting holes so that an angle of the mounting panel is adjusted.

3. The game stand according to claim 1, wherein a position-limiting structure is arranged on the first rack, and the other end of the pedal is in lap joint with the position-limiting structure, so that the first rack and the second rack are at a fixed angle after being unfolded.

4. The game stand according to claim 3, wherein the position-limiting structure comprises a movable sleeve arranged on the first rack, the movable sleeve is arranged on the first rack in a sleeving mode, and the movable sleeve can be adjusted through a bolt so that the movable sleeve is fixed at any position of the first rack.

5. The game stand according to claim 1, wherein the first rack comprises two first vertical rods parallel to each other and a first cross rod which is connected to ends of the two first vertical rods, and the mounting panel is connected between the other ends of the two first vertical rods.

6. The game stand according to claim 5, wherein the second rack comprises two second vertical rods parallel to each other and a second cross rod which is connected to ends of the two second vertical rods, and the other ends of the two second vertical rods are hinged to middle portions of the two first vertical rods respectively.

7. The game stand according to claim 6, wherein a fastener is arranged on the second rack, a fixing hole is formed in the pedal, and after the first rack and the second rack are folded, the fastener is inserted into the fixing hole so that the first rack and the second rack are in a folded state.

8. The game stand according to claim 5, wherein the first vertical rods are telescopic rods, and tightening nuts are arranged on the telescopic rods.

9. The game stand according to claim 1, wherein a gear lever supporting seat is further arranged on the stand body.

10. The game stand according to claim 1, wherein the angle adjusting structure comprises a fixing substrate, the fixing substrate is connected to the stand body, a threaded rod is arranged on the fixing substrate, a knob is arranged at one end of the threaded rod, the knob can be rotated to drive the threaded rod to rotate, a sliding block is arranged on the threaded rod and hinged to one side of the bottom of the mounting panel, and the other side of the bottom of the mounting panel is hinged to the fixing substrate.
